(19) United States
(12) Patent Application Publication
(10) Pub. No.: US 2005/0005388 A1
(43) Pub. Date: Jan. 13, 2005

(54) Transparent windshield wiper blade and arm

(76) Inventors: Russell J. Javaruski, Lakewood, NJ (US); Robert Gortner, West Creek, NJ (US)

Correspondence Address: Arthur M. Peslak, Esq.;MANDEL & PESLAK, LLC, Suite 5, 80 Scenic Drive, Freehold, NJ, 07728, US

(21) Appl. No.: 10/616,245

(22) Filed: Jul. 9, 2003

(51) Int. Cl. B60S 1/34; B60S 1/32; B60S 1/38

(52) U.S. Cl. 15/250.351; 15/250.48

(57) ABSTRACT

A transparent windshield wiper assembly is disclosed. The construction details of the assembly are similar to the construction of conventional available wipers but the assembly is fabricated from transparent plastic materials.

### BACKGROUND OF THE INVENTION

The present invention is directed to the field of windshield wipers. There are several problems with existing windshield wipers. The first relates to visibility. Since the blades and arms of windshield wipers are generally black or another dark color, the existing windshield wipers generally act to obstruct the driver's vision to some extent. In addition, during long periods of driving with the windshield wipers operating, the constant motion of the windshield wipers can have a hypnotic effect on the driver causing the driver to become drowsy. Both of these problems create potential safety issues. The object of the present invention is to provide a windshield wiper that solves these safety problems.

### SUMMARY OF THE INVENTION

The present invention is directed to a windshield wiper blade and arm that solves the aforementioned safety defects in available windshield wipers. The present invention is directed to a windshield wiper blade and arm assembly fabricated from transparent plastic type material. By fabricating the assembly from such material, the obstruction of the driver's vision during operation is reduced significantly. In addition, the hypnotic effect of the windshield wiper is also reduced.

### BRIEF DESCRIPTION OF THE DRAWINGS

FIG. 1 is a perspective view of the present invention.

FIG. 2 is a front view of the present invention.

FIG. 3 is a rear view of the present invention.

FIG. 4 is a side view of the present invention.

FIG. 5 is a side view of the present invention.

FIG. 6 is a side view of the present invention.

FIG. 7 is a side view of the present invention.

### DETAILED DESCRIPTION OF THE INVENTION

The present invention will now be described in the context of the presently preferred embodiment of the invention as shown in the drawing. Those of ordinary skill in the art will recognize that the present invention is not limited to the embodiment described herein.

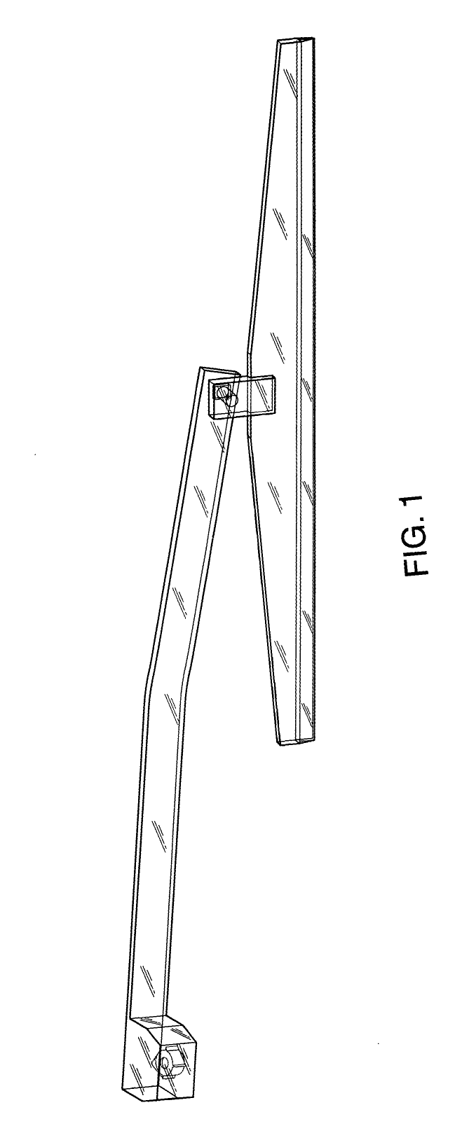

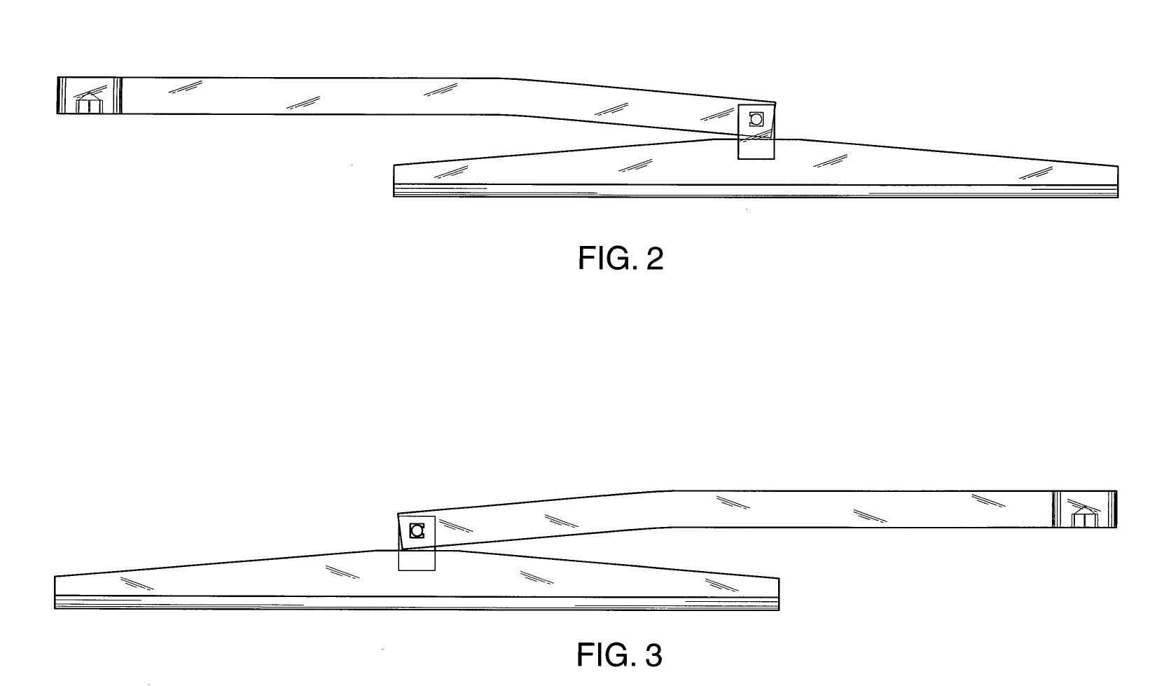

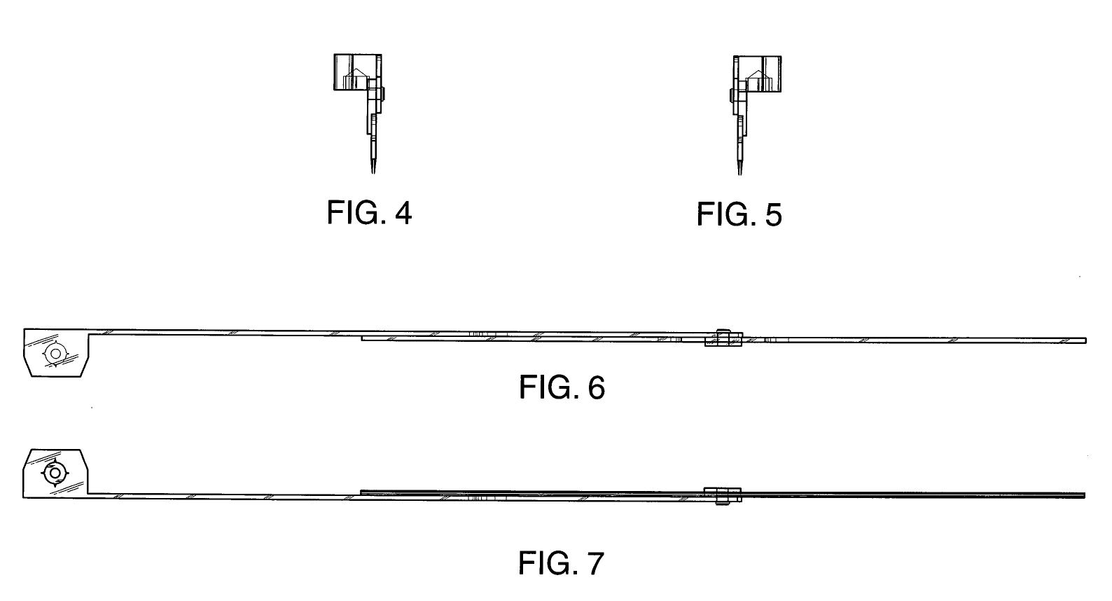

FIG. 1 illustrates the windshield wiper and blade assembly of the present invention. As can be seen from FIG. 1, the size, shape, and configuration of the windshield wiper of the present invention is presently contemplated to be identical to presently available windshield wiper assemblies. The difference between the present invention and prior windshield wiper assemblies is that the present invention is fabricated from transparent plastic material. The wiper arm is presently contemplated to be fabricated from a rigid plastic material such as Polycarbonate. The wiper blade is presently contemplated to be fabricated from a flexible rubber like plastic material such as Silicone Base.

In use, the present invention will greatly reduce, if not eliminate, the vision obstruction that occurs with a conventional black windshield wiper assembly. The transparency of the present invention will also greatly reduce the hypnotic effect from prolonged windshield wiper use since during use, the assembly will be virtually invisible.

Those of ordinary skill in the art will recognize that the embodiment just described merely illustrates the principals of the present invention. Many modifications may be made thereto without departing from the spirit and scope of the present invention as set forth in the following claims.

1) An improved windshield wiper assembly comprising a wiper arm fabricated from a rigid transparent material and a wiper blade attached to the wiper arm fabricated from a flexible transparent material.

2) The windshield wiper assembly of claim 1 wherein the wiper arm is fabricated from Polycarbonate and the wiper blade is fabricated from Silicone Base.
